(19) United States
(12) Patent Application Publication
(10) Pub. No.: US 2009/0200062 A1
(43) Pub. Date: Aug. 13, 2009

(54) Electric supply device for slide structure

(75) Inventor: Tohru Aoki, Susono (JP)

Correspondence Address: EDWARDS ANGELL PALMER & DODGE LLP, P.O. BOX 55874, BOSTON, MA, 02205, US

(73) Assignee: Yazaki Corporation, Tokyo (JP)

(21) Appl. No.: 12/314,357

(22) Filed: Dec. 9, 2008

(30) Foreign Application Priority Data
Feb. 13, 2008 (JP) 2008-031892

(51) Int. Cl. H01B 7/24

(52) U.S. Cl. 174/136

(57) ABSTRACT

The present invention is to provide an electric supply device for a slide structure, which can prevent drooping of a wiring harness. The electric supply device for the slide structure has a wiring harness arranged to extend from a base body to a slide structure slidably provided on the base body, a guide rail arranged along a slide direction of the slide structure in one of the base body or the slide structure, a slider supporting one end of the wiring harness and slidabaly arranged on the guide rail, a supporting member supporting another end of the wiring harness and fixed in the other of the base body or the slide structure and an angel offset means. The angel offset means turns a derivation direction X leading the wiring harness from one of the slider or the supporting member above a horizontal direction H.

### BACKGROUND OF THE INVENTION

1. Field of the Invention

The present invention relates to an electric supply device for a slide structure having a wiring harness so as to supply electric power to a slide door from a main body of a vehicle.

2. Description of the Related Art

The conventional various electric supply devices for a slide structure (hereafter, the electric supply device) are used so as to supply always an electric power to an auxiliary machine mounted on a slide door as the slide structure of a motor vehicle, for example a power window motor, a door lock unit and so on.

As shown in FIG. 8, the electric supply device 110 described in the patent document 1 (see Japanese published patent application No. 2001-354085) includes a wiring harness 103 on the side of a door (hereafter, the door side wiring harness 103)and a protector 109. The door side wiring harness 103 is arranged to extend from a slide door 101 to a vehicle body 102. The protector 109 receives the door side wiring harness 103, and is mounted on an inner panel 108 of an inner surface side in the slide door 101.

In the door side wiring harness 103, one end of the door side wiring harness 103 is connected to the auxiliary machine (not shown) mounted on the side of the slide door 101 through a connector 104. Another end thereof is fixed to a connector 107, which is arranged in a vertical wall 117 vertically -arranged from a step 116 of the vehicle body 102, through a connector 105 and connected to a device (not shown) mounted on the vehicle body 102 such as a battery.

The protector 109 receives an arc-curved segment 120 of the door side wiring harness 103 and protects the door side wiring harness 103. In the bottom part of the protector 109, a guide rail 130 arranged along a slide direction of the slide door 101 and a slider 131 slidably arranged in the guide rail 130 are included. The slider 131 includes a protrusion projecting into a horizontal direction and a first arm member 141. The first arm member 141 is rotatably attached to the protrusion, and guides a corrugated tube 119, which is provided on the wiring harness 103 as exterior components, toward the vehicle body 102. The corrugated tube 119 is arranged to extend from the first arm member 141 to the connector 105.

According to the electric supply device 110, since the slider 131 includes the first arm member 141, the corrugated tube 119 (that is, the door side wiring harness 103) can be oscillatably held in an opening/closing direction of the slide door 101. Thereby, the wiring harness 103 can be moved smoothly.

However, the first arm member 141 supports the corrugated tube 119 toward the vehicle body 102 so as to lead to a horizontal direction. Furthermore, the corrugated tube 119 is made of synthetic resin having the flexibility so that the corrugated tube can be bent according to a slide movement of the slide door 101. Because of this, the corrugated tube 119 is deformed by temperature change and a bending tendency. As shown in FIG. 9, the corrugated tube 119 arranged to extend from the slide door 101 to the vehicle body 102 dangles downward lower than a horizontal direction H with a distance D. Thereby, the corrugated tube 119 comes in contact with the step 116. As a result, the above electric supply device will cause an abnormal noise and damage of the wiring harness 103. Meanwhile, in consideration of the above drooping of the wiring harness 103, the above problem can be prevented by spacing between the electric supply 110 and the step 116 and mounting the electric supply 110. However, in such cases, a wide space is required so as to mount the electric supply 110. Thereby, when the electric supply 110 is mounted on a vehicle, the electric supply 110 is limited.

### SUMMARY OF THE INVENTION

It is an object of the present invention to solve the above problems. That is, the object of the present invention is to provide an electric supply device for a slide structure, which can prevent drooping of a wiring harness.

According to a first object of the present invention, an electric supply device for a slide structure has a wiring harness, a guide rail, a slider, a supporting member, and an angle offset means. The wiring harness is arranged to extend from a base body to a slide structure slidably provided on the base body. The guide rail is arranged on one of the base body or the slide structure along a sliding direction of the slide structure. The slider supports one end of the wiring harness and slidably arranged on the guide rail. The supporting member supports another end of the wiring harness and fixed in the other of the base body or the slide structure. The angle offset means turns a direction leading the wiring harness from at least one of the slider or the supporting member above a horizontal direction.

Preferably, the electric supply device for the slide structure is an inclined member. The inclined member inclines a rail surface of the guide rail guiding a slide movement of the slider so that a lower end of the rail surface is gradually away from one of the base body or the slide structure arranged on the guide rail.

With the construction described above, the wiring harness extending from the slider to the supporting member can be curved like a mountain. That is, a curvature of the wiring harness can be curved upward. Thereby, a downward drooping lower than a horizontal direction can be prevented. Furthermore, the wiring harness can be avoided from contact with the base body or the slide structure.

With the construction described above, the rail surface of the guide rail (that is, a direction perpendicular to the rail surface) can be turned upward. Thereby, a derivation direction of the wiring harness can be located upward higher than the horizontal direction easily. Therefore, the drooping of the wiring harness lower than the horizontal direction can be easily prevented.

The above and other objects and features of this invention will become more apparent from the following description taken in conjunction with the accompanying drawings.

### BRIEF DESCRIPTION OF THE DRAWINGS

FIG. 1 is a perspective view showing a preferred embodiment of an electric supply device for a slide door according to the present invention;

FIG. 2 is an exploded view of the electric supply for the slide door in FIG. 1;

FIG. 3 is a perspective view of a guide rail in FIG. 1;

FIG. 4 is a side view of the guide rail of arrow B1 direction in FIG. 3;

FIG. 5 is a side view of the guide rail of arrow B2 direction in FIG. 3;

FIG. 6 is a sectional view taken along the line A-A in FIG. 1

FIG. 7 shows a typical condition of drooping of a wiring harness which is arranged to extend from a vehicle body to a slide door in FIG. 1;

FIG. 8 is an exploded view of a conventional electric supply device for a slide door; and

FIG. 9 shows a typical condition of drooping of a wiring harness which is arranged to extend from a vehicle body and a slide door in the conventional electric supply device for the slide door.

### DESCRIPTION OF THE PREFERRED EMBODIMENT

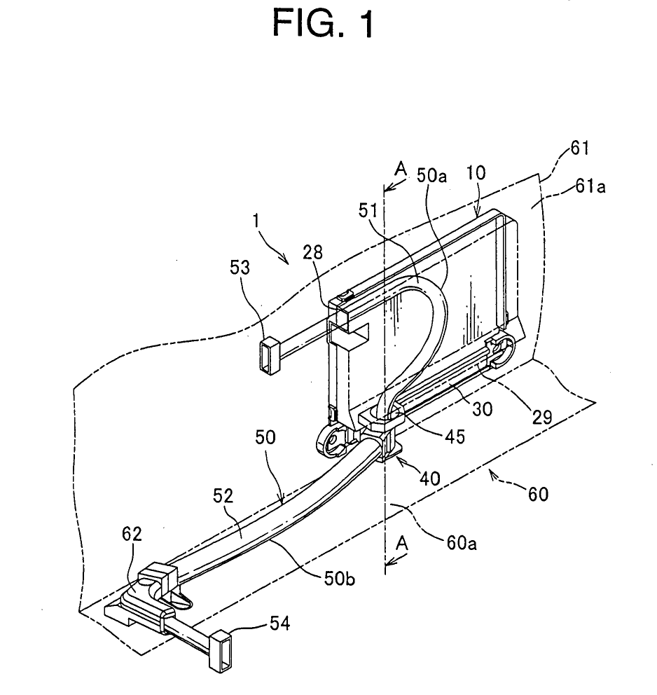

Referring now to FIGS. 1 through 6, an electric supply device for a slide door (hereafter, the electric supply device) of a preferred embodiment of the present invention is described below.

The electric supply device 1 corresponds to an electric supply device for a slide structure in claims. The electric supply device 1 is arranged on a vehicle having a slide door, and always supplies electric power to a power window motor mounted on the slide door, a door lock unit, and an auxiliary machine of speaker. As shown in FIG. 1, the electric supply device 1 includes a wiring harness 50, a protector 10 receiving the wiring harness 50, a guide rail 30 attached to the bottom of protector 10, a slider 40 slidably attached to the guide rail 30, and a fixed portion 62 attached to a vehicle body 60.

In FIG. 1, the slide door 61 is slidably provided in a back and forth direction (a right/left direction of FIG.1) of the vehicle body 60 by a slide supporting member (not shown) The protector 10 is attached to an inner panel 61a so that an attachment surface of the protector 10 is vertically arranged inside of the slide door 61. In the wiring harness 50 led from a first opening 28 of the protector 10, a connector 53 arranged in a top portion thereof is connected to an auxiliary machine (not shown) of the slide door 61. The wiring harness 50 led from a second opening 29 of the protector 10 is arranged to extend from a slider 40 to the fixed portion 62 provided on a step 60a of the vehicle body 60. A connector 54 arranged in a top portion thereof is connected to an electric supply portion (not shown) of the vehicle body. The slide door 61 corresponds to a slide structure in claims, and also the vehicle body 60 corresponds to a base body.

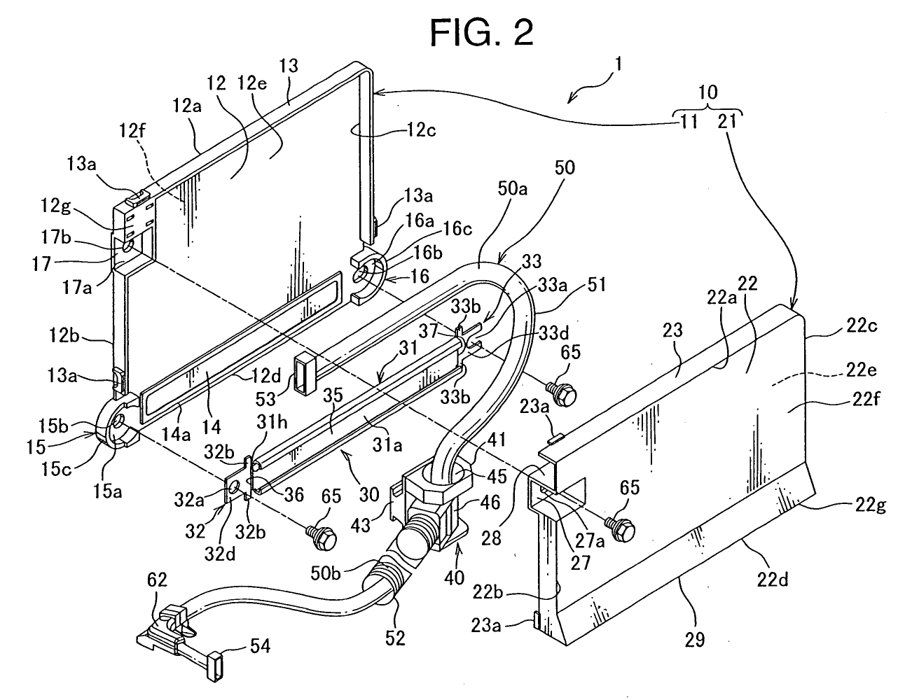

The protector 10 receives a curved segment 50a of the wiring harness 50 inside and protects. Further, the protector 10 changes a diameter of the curved segment 50a depending on the slide of slide door 61. As a result, a slack of the wiring harness is absorbed. The protector 10 is attached to the inner panel 61a of the slide door 61. As shown in FIG. 2, the protector 10 includes a base 11 and a cover 21.

The base 11 is made of synthetic resin, and includes a base plate 12, a side wall 13, a guide rail attaching portion 14, and clamping portions 15, 16, 17.

The base plate 12 is formed into a rectangular plane shape. The base plate 12 is spaced from the cover 21, and arranged in opposition to the cover 21. Thereby, a space for receiving the curved segment 50a of the wiring harness 50 is formed between the base plate 12 and the cover 21. As a result, movement of the curved segment 50a received in the space, that is, movement of the wiring harness 50 in a direction perpendicular to the base plate 12 is controlled. The base plate 12 has an upper side 12a (the upper side in FIG. 2), one side 12b (the left side in FIG. 2), the other side 12c and a bottom side 12d. On a corner of upper side 12a and the one side 12b, a derivation portion 12g is arranged. The derivation portion 12g is formed in a rectangular flat surface. A part of the wiring harness 50 is fixed on the flat surface of the derivation portion 12g by a fixed member (not shown) formed with a belt shape. In the base plate 12, the clamping portion 17 is arranged. The clamping portion 17 has a rectangular clamping surface 17a and a circular screw hole 17b. The clamping surface 17a is in the base plate 12, and the screw hole 17b passes through a central portion of the clamping surface 17a. An outer surface 12f of the base plate 12 is a mounting surface in the protector 10, and is connected to the inner panel 61a.

The side wall 13 is vertically stood toward an inner surface 12e from each side, more specifically, from the upper side 12a, the one side 12b and the other side 12c. That is, the side wall 13 locates the clamping portion 17 to an outer side thereof, and locates the derivation portion 12g and a flat surface of the base plate 12 to an inner side thereof. Thereby, the side wall 13 is formed around the base plate 12. A height of the side wall 13 is equal to a height of the derivation portion 12g. In the side wall 13, three fixed slits 13a are provided on the upper side 12a, the sides 12b and 12c so as to hook the cover 12 to the base 11.

The guide rail attaching portion 14 is arranged to extend in a longitudinal direction along the bottom side 12d of the base plate 12, and is located at the bottom of the base plate 12. The guide rail attaching portion 14 has a rectangular frame projection 14a which is arranged along the bottom side 12d of the base plate 12. When the guide rail attaching portion 14 is fit and attached to a rail 30 of a guide rail 30, the frame projection 14a prevents looseness. Furthermore, the frame projection 14a is inclined so that a lower end of the frame projection 14a is gradually away from the inner surface 12e. An angle of inclination is a 1.5 degrees angle against the flat surface of the base plate 12 (flat surface direction). It is required to adjust this angle depending on construction of an electric supply device for a slide door, for example, wiring harness length and the number of circuits including the wiring harness.

The clamping portion 15 is arranged in one end (left side in FIG. 2) of the guide rail attaching portion 14 together with the base 11. The clamping portion 15 has a semicircular clamping surface 15a, a circular screw hole 15b, and a peripheral wall 15c. The clamping surface 15a is projected from the one side 12b of the base plate 12. The screw hole 15b passes through a central portion of the clamping surface 15a. The peripheral wall 15c is vertically arranged along a circular arc of the clamping surface 15a.

The clamping portion 16 is arranged in another end (right side in FIG. 2) of the guide rail attaching portion 14 together with the base 11. The clamping portion 16 has a semicircular clamping surface 16a, a elliptical screw hole 16b, and a peripheral wall 16c. The clamping surface 16a is projected from the other side 12c of the base plate 12. The screw hole 16b passes through a central portion of the clamping surface 16a, and the elliptical diameter of the screw hole 16b is arranged along a longitudinal direction of the guide rail attaching portion 14. The peripheral wall 16c is vertically arranged along a circular arc of the clamping surface 16a. The screw hole 16b is formed in a elliptical shape so as to adjust a assembly error.

The cover 21 is made of synthetic resin in common with the base 11. As shown in FIG. 2, the cover 21 includes a base plate 22, a side wall 23, a clamping portion 27, the first opening 28 and the second opening 29.

The base plate 22 is formed into a rectangular plane shape as the base plate 12 of the base 11 which is surrounded by the side wall 13. The base plate 22 is spaced from the base plate 12, and arranged in opposition to the base plate 12 of the base 11. Thereby, a space for receiving the curved segment 50a of the wiring harness 50 is formed between the base plate 12 and the cover 11. As a result, movement of the curved segment 50a received in the space is controlled in a direction perpendicular to the base plate 22. The base plate 22 has a flange 22g. The flange 22g is formed to protrude toward an outer surface 22f and is arranged along a bottom side 22d.

The clamping portion 27 is arranged at a corner of an upper side 22a and one side 22b in the base plate 22, and formed in a rectangular plane shape. When the base 11 is combined with the cover 21, the clamping portion 27 is connected to the clamping portion 17 of the base 11. Also, the screw hole 27a is coaxially arranged to the screw hole 17b of the clamping portion 17. By a screw. 65 passing through the screw holes 27a and 17b, the base 11 and the cover 65 are fixed in the slide door 61 together.

The side wall 23 is vertically stood toward an inner surface 22e from each side, more specifically, from the upper side 22a, the one side 22b and another side 22c. That is, the side wall 23 locates the clamping portion 27 to an outer side thereof, and locates a flat surface of the base plate 22 to an inner side thereof. Thereby, the side wall 23 is formed around the base plate 22. A height of the side wall 23 is nearly equal to the outer diameter of the wiring harness 50 in accordance with the side wall 23 of the base 11. That is, when the base 11 is combined with the cover 21, the side wall 23 is overlapped with the side wall 13 of the base plate 12 in a height direction. Furthermore, a space on the same height of the outer diameter of the wiring harness 50 is formed inside thereof. In the side wall 23, three fixed pieces 23a are provided on the upper side 22a, the sides 22b and 22c so as to hook the cover 12 to the base 11 (the fixed piece 23a of the side 22c is not shown). The fixed piece 23a is fit in the fixed slit 13a.

The first opening 28 is arranged on an upper portion of the one side 22b in the side wall 23, and formed in a rectangular shape slightly larger than the outer diameter of the wiring harness 50. When the base 11 is combined with the cover 21, the first opening 28 is overlapped with the derivation portion 12g. The first opening 28 leads one end of the wiring harness 50 connected to the slide door 61.

The second opening 29 is arranged along the bottom side 22d of the base plate 22, and is formed in a slit shape. When the base 11 is combined with the cover 21, the second opening 29 is opened toward the guide rail attaching portion 41 of the base 11 and located. The second opening 29 leads another end of the wiring harness 50 connected to the vehicle body 60. Since the second opening 29 is formed in a slit shape, the wiring harness 50 led from the second opening 29 can be moved along a longitudinal direction of the guide rail attaching portion 14. In addition, since the flange 22g is arranged along the second opening 29, the led wiring harness 50 is bent along the flange 22g. Thereby, the wiring harness 50 can be moved smoothly. Furthermore, damage of the wiring harness 50 by contacting with an edge of the bottom side 22d in the base plate 22 can be prevented.

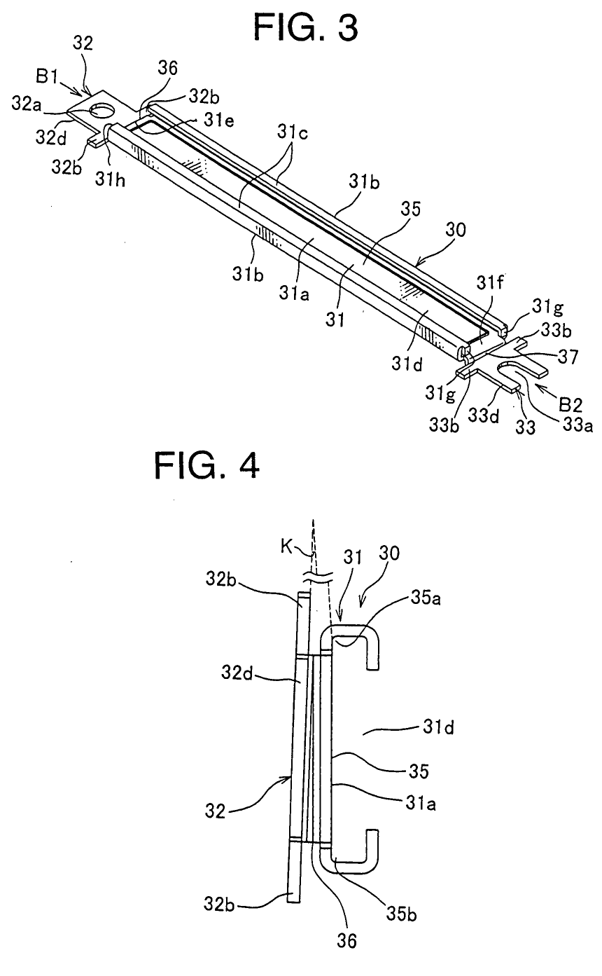

The guide rail 30 is a member for guiding movement of the wiring harness 50 led from the protector 10, and is formed by bending a plate, which is punched in a predefined shape, into a rectangular shape. The guide rail 30 is attached to the guide rail attaching portion 14 provided on the base 11. As shown in FIG. 3, the guide rail 30 includes a rail 31, brackets 32, 33, and connections 36, 37.

The rail 31 is a member for slidably supporting the slider 40. The rail 31 includes a rectangular bottom wall 31a, a pair of side walls 31b, a pair of flange walls 31c and a guide groove 31d. The side walls 31b are vertically stood from the bottom walls 31a. The flange walls 31c are vertically stood from the side walls 31b in a direction opposed to the bottom wall 31a each other. The side walls 31b and the flange walls 31c are arranged along a longitudinal direction of the bottom wall 31a. In the bottom wall 31a, a projection (not shown) fitting with the frame projection 14a is arranged on a surface opposed to the guide rail attaching portion 14. A surface of the guide groove 31d side (hereafter, rail surface 35) in the bottom wall 31a corresponds to a rail surface in claims.

In one end 31e of the rail 31, a slider attachment inlet 31h is arranged. The slider attachment inlet 31h is opened and formed in the same shape as a cross section of the guide groove 31d. A leg portion 43 of the slider 40 described below is installed from the slider attachment inlet 31h in the guide groove 31d, and is attached to the guide rail 30. In the other end 31f of the rail 31, a stopper 31g projecting toward the bottom wall 31a from the flange wall 31c is arranged. When the leg portion 43 of the slider 40 touches the stopper 31g, movement of the slider 40 is controlled. Thereby, the slider 40 can be prevented from falling off from another end 31f.

The bracket 32 fixes the rail 31 (that is, the guide rail 30) in the protector 10, and includes a tabular attaching portion 32d and a circular screw hole 32a. The attaching portion 32d is formed into a rectangle. The screw hole 32a passes through a center of the attaching portion 32d. When the guide rail 30 is located in the guide rail attaching portion 14, the attaching portion 32d of the bracket 32 contacts with the clamping surface 15a inside the peripheral wall 15 of the clamping portion 15 in the protector 10. Furthermore, the screw hole 32a overlaps coaxially the screw hole 15b of the protector 10. In the attaching portion 32d, a pair of projection pieces 32b is arranged. The projection pieces 32b are projected in a direction away from one end of a pair of sides opposite to each other. Preferably, the screw hole 32a is formed in the same diameter as the screw hole 15b. When the screw hole 32a is overlapped with the screw hole 15b, the screw 65 is passed through the screw holes and is fastened. Thereby, the protector 10 and the guide rail 30 are fixed in the inner panel 61a of the slide door 61.

The connection 36 corresponds to an angel offset means in claims. The connection 36 is an inclined member for connecting the bracket 32 with the rail 31. In particular, as shown in FIG. 4, the connection 36 inclines gradually the rail surface 35 of the guide rail 30 against a flat surface of the attaching portion 32d from one long side 35a toward another long side 35b. That is, the bracket 32 and the one end 31e of the rail 31 are connected as incline at an angle of K degree. The angle K is equal to the angle of inclination of the frame projection 14a.

The bracket 33 is a member for fixing the rail 31 (that is, the guide rail 30) in the protector 10 with the bracket 32. The bracket 33 includes a tabular attaching portion 33d and a semicircular screw hole 33a. The attaching portion 33d is formed into a rectangle shape. The screw hole 33a is cut from one side located at the top of the attaching portion 33d, formed in a semicircle shape, and positioned at a center of the attaching portion 33d. When the guide rail 30 is located in the guide rail attaching portion 14, the attaching portion 33d of the bracket 33 contacts with the clamping surface 16a inside the peripheral wall 16 of the clamping portion 16 in the protector 10. Furthermore, the screw hole 33a overlaps coaxially the screw hole 16b of the protector 10. Thereby, since the screw holes 33a and 16b are overlapped each other, they are fastened by a common screw. In the attaching portion 33d, a pair of projection pieces 33b is arranged. The projection pieces 33b are projected in a direction away from one end of a pair of sides opposite to each other. In addition, the attaching portion 33d is formed in the same plane with the attaching portion 32d. Preferably, the screw hole 33a is formed in the same diameter as the screw hole 16b. When the screw hole 33a is overlapped with the screw hole 16b, the screw 65 is passed through the screw holes and is fastened. Thereby, the protector 10 and the guide rail 30 are fixed in the inner panel 61a.

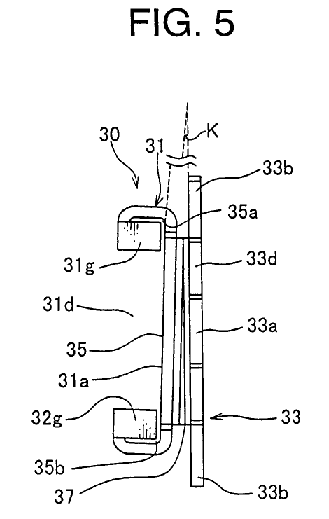

The connection 37 corresponds to the angel offset means in claims. As with the connection 36, the connection 37 is an inclined member for connecting the bracket 33 with the rail 31. In particular, as shown in FIG. 5, the connection 37 inclines gradually the rail surface 35 of the guide rail 30 against a flat surface of the attaching portion 33d from the one long side 35a toward another long side 35b. That is, the bracket 33 and another end 31f of the rail 31 are connected as incline at the same K degree as the connection 36.

Consequently, by the connections 36, 37, the guide rail 30 can be attached to the protector 10. More specifically, the rail surface 35 of the guide rail 30 can be attached to the protector 10 at an angle of K degree against a flat surface of the base plate 12. Thus, when the protector 10 is attached to the inner panel 61a, the rail surface 35 of the guide rail 30 can be inclined so that a lower end of the rail surface 35 is gradually away from the protector 10 (that is, the inner panel 61a).

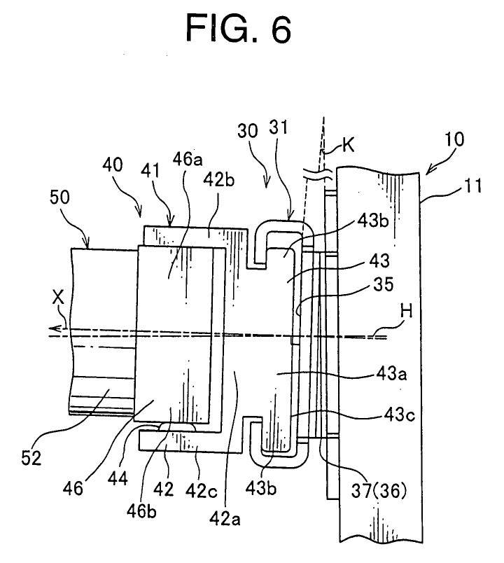

The slider 40 is a member for guiding movement of the wiring harness 50 led from the second opening 29 with guide rail 30. Furthermore, the slider 40 holds a part of the wiring harness 50, and is slidably attached to the guide rail 30. As shown in FIG. 6, the slider 40 includes a slider body 41 and a swing member 46.

The slider body 41 is made of synthetic resin, and includes a supporting member 42 and the leg portion 43 connected to the supporting member 42.

The supporting member 42 includes a bottom wall 42a having a rectangular wall surface, and a pair of side walls 42b, 42c. The side walls 42b and 42c are vertically stood opposite to each other in an inner wall surface of the bottom wall 42a. In the slider 40, a through hole 45 for passing the wiring harness 50 through the swing member 46 is arranged. In the side wall 42b, a shaft portion (not shown) is arranged in a surface opposite to the side wall 42c. The shaft portion is formed into a ring shape and provided along circumference of the through hole 45. In addition, the shaft portion rotatably supports the swing member 46. In the side wall 42c, a shaft portion 44 is arranged in a surface opposite to the side wall 42b. The shaft portion 44 rotatably supports the swing member 46 with the above shaft portion arranged on the side wall 42b.

The leg portion 43 includes a prismatic-shaped basal portion 43a and a pair of projections 43b. The basal portion 43a is vertically stood in an outer wall surface of the bottom wall 42a. The projections 43b projects from a side surface of a top portion of the basal portion in a direction away from the pair of the side walls 42b (that is, a direction that the side walls 42b are opposed each other). A width of the basal portion 43a (width of a long side direction in the bottom wall 42a) is smaller than a space between the flange walls 31c (that is, a width of the guide groove 31d). Also, a height of the basal portion 43a is larger than a space between the flange wall 31c and the bottom wall 31a (that is, a length from the flange wall 31 to the bottom wall 31a). The projections 43b are formed along an overall length of the basal portion 43a. A length between both ends of the projections 43b is equal to a width of the guide groove 31d. A depth of the projection 43b is slightly smaller than a space between the bottom wall 31a and the flange wall 31c. That is, the leg portion 43 contacts slidingly an outer surface 43c of the basal portion 43a in the rail surface 5, and is slidably engaged with the guide groove 31d of the guide rail 30.

The swing member 46 is made of synthetic resin, and formed into a rectangular parallelepiped shape. The swing member 46 can be separated into an upper piece 46a and a under piece 46b. Further, the swing member 46 is rotatably supported by the shaft portion of the supporting member 42. The swing member 46 includes a tube mounting hole (not shown) and a through hole (not shown). The tube mounting hole is opened in the center of one surface of the swing member 46. The through hole is arranged on a upper surface of the swing member 46 coaxially with the through hole 45 of the supporting member 42, and is passed through the tube mounting hole. The upper piece 46a and the under piece 46b are respectively fixed by a latching member.

The swing member 46 is led from the second opening 29 from the above through hole to the tube mounting hole. Also, the wiring harness 50, which is inserted into the through hole 45 of the supporting member 42, is passed through the swing member 46. In the tube mounting hole, one end of a corrugated tube 52 is held. The corrugated tube 52 is exterior components of the wiring harness 50. More specifically, a plurality of ribs (not shown) is provided in an extended condition along a circumferential direction in an inner circumference surface of the tube mounting hole. The ribs, a projection and dent (not shown), which are provided on an outer circumference of the corrugated tube 52, are engaged and fixed.

Each member of the slider 40 is formed so that a supporting direction of the corrugated tube 52 (that is, a derivation direction X of the wiring harness 50 led from the tube mounting hole), which is fixed in the tube mounting hole, is turned in a direction perpendicular to the outer surface 43c of the basal portion 43a of the leg portion 42. When the slider 40 is attached to the guide rail 30, the derivation direction X of the wiring harness 50 led from the slider 40 is turned in a direction perpendicular to the rail surface 35 of the guide rail 30.

The fixed portion 62 corresponds to a supporting member in claims. The fixed portion 62 is a member for fixing and attaching the wiring harness 50 in the vehicle body 60. The fixed portion 62 is formed into L-shaped, and attached to the step 60a of the vehicle body 60. One end of the fixed portion 62 is directed at a front of the vehicle (right side in FIG. 1), and another end is directed inside the vehicle (front side in FIG. 1). The fixed portion 62 is formed into a tubular shape communicating the one end with another end. The wiring harness 50 is inserted inside the fixed portion 62. Thereby, the wiring harness 50 is fixed toward a front and inside of vehicle. Another end of the corrugated tube 52 is held to one end of the fixed portion 62.

The wiring harness 50 is arranged to extend from the vehicle body 60 to the slide door 61. The wiring harness 50 is a member for supplying an electric power to an auxiliary machine mounted on the slide door 61. Furthermore, the wring harness 50 includes a harness 51 in which a plurality of electric wires is bundled, the connectors 53, 54 and the corrugated tube 52. The connector 53 is arranged at one end connected to the slide door 61 in the harness 51. The connector 54 is arranged at another end connected to the vehicle body 60 in the harness 51.

The wiring harness 51 has the curved segment 50a and a connecting portion 50b. The curved segment 50a is curved and received in the protector 10. The connecting portion 50b is protected by the corrugated tube 52 and connected from the slide door 61 to the vehicle body 60.

The corrugated tube 52 is made of synthetic resin having the flexibility. A shape at cross section of the corrugated tube 52 is formed into a round or elongated shape. The corrugated tube 62 is a tubular exterior component. The harness 51 is inserted into the corrugated tube 62, and protected. One end of the corrugated tube 52 is rotatably supported to the swing member 46 of the slider 40 in a slide direction, and another end is fixed to the fixed member 62 toward a front of the vehicle (right side in FIG. 1).

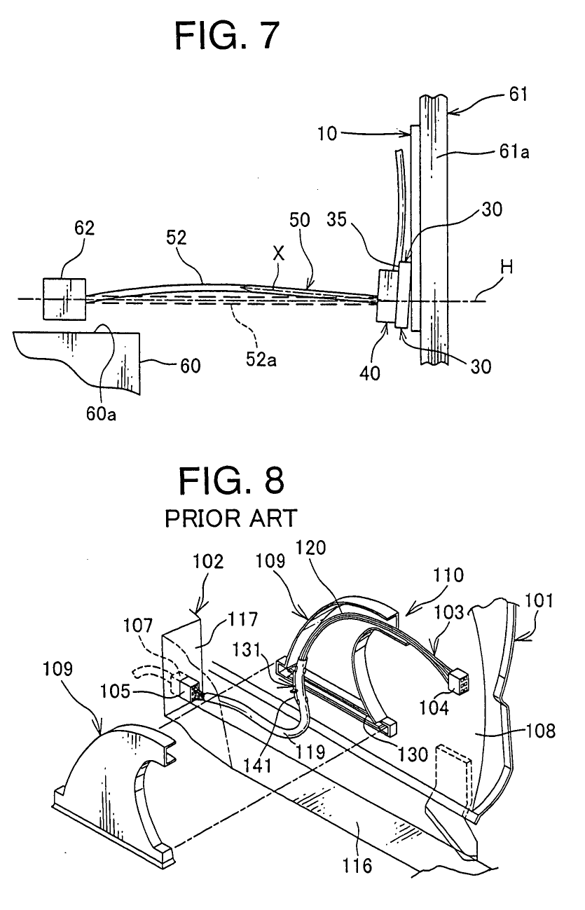

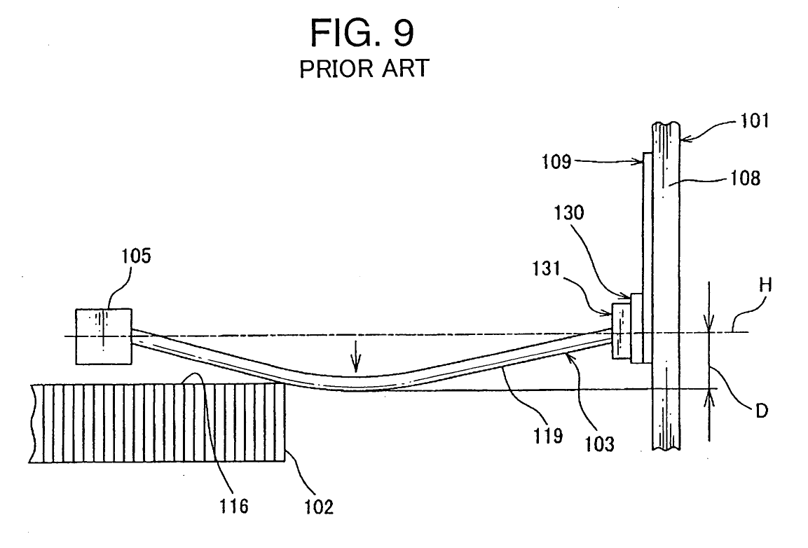

The following describes the electric supply device 1 of the present invention in detail with reference to FIG. 7.

FIG. 7 shows a typical condition of drooping of the wiring harness 50 which is arranged to extend from the vehicle body 60 to slide door 61 in the electric supply device 1.

As shown in FIG. 7, the protector 10 is arranged on the inner panel 61a of the slide door 61 so that a flat surface of the basal portion 12 of the base 11 in the protector 10 is vertically arranged. The guide rail 30 is arranged to the protector 10. The rail surface 35 thereof is gradually inclined downward against the protector 10. That is, the rail surface 35 is gradually inclined so that a lower end of the rail surface 35 is away from the protector 10. The derivation direction X of the wiring harness 50 which is led from the slider 40 is arranged in a direction perpendicular to the rail surface 35 of the guide rail 30, and is directed to an upside direction in 1.5 degree above a horizontal direction H. Thereby, a curvature of the wiring harness 50 arranged between the slider 40 and the fixed portion 62 (that is, corrugated tube 52) can be located in an upside higher than the horizontal direction H, and become like a mountain. Therefore, even if a drooping condition of the corrugated tube 52 is caused, the corrugated tube 52 can be held in a position of a dotted line shown in FIG. 7. In addition, contact of the corrugated tube 52 with the step 60a can be prevented.

According to the present invention, the electric supply device includes the connections 36, 37 for placing the derivation direction X in an upper direction higher than the horizontal direction H. Thereby, the corrugated tube 52 arranged between the slider 40 and the fixed portion 62 (that is, the wiring harness 50) can be located like a mountain in which a curvature of the corrugated tube 52 is turned upward. Therefore, a drooping of the wiring harness 50 can be presented. Furthermore, the wiring harness 50 can be prevented from contacting with the vehicle body 60.

The connections 36, 37 are the inclined member formed in the guide rail 30 together. Furthermore, the connections 36, 37 incline the rail surface 35 of the rail 30 so that the lower end of the rail surface is gradually inclined from the slide door 61. Thereby, the guide surface 35 of the guide rail 30 (that is, in a direction perpendicular to the rail surface 35) can be turned in an upper direction. Also, the derivation direction X of the wiring harness 50 in the slider 40 arranged on the guide rail 30 can be positioned above the horizontal direction H easily. Therefore, the wiring harness 50 can be prevented from down ward drooping lower than the horizontal direction H. Additionally, since the connections 36, 37 are formed with the guide rail 30 together, the derivation direction X can be located in an upper direction higher than the horizontal direction H without addition of another member and cost-up.

In the embodiment, the guide rail 30 is arranged on the slide door 61 but not limited thereto. The guide rail 30 can be arranged in vehicle body 60.

Also, the connections 36, 37 (that is, angle offset means) are arranged into the guide rail 30 together but not limited thereto. A derivation portion of the slider 40 and/or the fixed portion 62 can be formed so as to turn the derivation portion thereof above the horizontal direction H.

The embodiment relates to a slide door as a slide structure mounted on the vehicle body but not limited thereto. The present invention can be applied to a slide structure which needs electric power.

The above described embodiments are only exemplary but not limited thereto. Any modifications and alterations thereof are within the scope of the present invention.

What is claimed is:

1. An electric supply device for a slide structure comprising:
a wiring harness arranged to extend from a base body to a slide structure slidably provided on the base body;
a guide rail arranged on one of the base body or the slide structure along a sliding direction of the slide structure;
a slider supporting one end of the wiring harness and slidably arranged on the guide rail; and
a supporting member supporting another end of the wiring harness and fixed in the other of the base body or the slide structure;
wherein the electric supply device for the slide structure includes an angle offset means for turning a direction leading the wiring harness from at least one of the slider or the supporting member above a horizontal direction.

2. The electric supply device as claimed in claim 1, wherein the angle offset means is an inclined member, the inclined member inclines a rail surface of the guide rail guiding a slide movement of the slider so that a lower end of the rail surface is gradually away from one of the base body or the slide structure arranged on the guide rail
